(19) United States
(12) Patent Application Publication
(10) Pub. No.: US 2014/0129373 A1
(43) Pub. Date: May 8, 2014

(54) ITEM RECOMMENDATIONS BASED ON TRUE FIT DETERMINATION

(71) Applicant: Amit Reuven Menipaz, Los Gatos, CA (US)

(72) Inventor: Amit Reuven Menipaz, Los Gatos, CA (US)

(73) Assignee: eBay Inc., San Jose, CA (US)

(21) Appl. No.: 13/828,889

(22) Filed: Mar. 14, 2013

Related U.S. Application Data
(60) Provisional application No. 61/721,704, filed on Nov. 2, 2012.

(51) Int. Cl. G06Q 30/06

(52) U.S. Cl. CPC G06Q 30/0631
USPC 705/26.7

(57) ABSTRACT

An apparatus and method to facilitate providing item recommendations are disclosed herein. A determination of same wearable items purchased by both of at least a first user and a second user is made. At least one of a first other wearable item purchased by the first user or a second other wearable item purchased by the second user is identified. A first physical fit of wearable items in the same item categorgy for the first user and a second physical fit of the wearable items in the same item category for the second user are automatically determined. The automatic determination is based on the determination of the same wearable items. Identification of the first other wearable item is provided to the second user as an item recommendation. The identification including a particular size from among a plurality of sizes of the identified first other wearable item.

### CROSS-REFERENCE TO RELATED APPLICATIONS

This application claims priority to U.S. Provisional Patent Application No. 61/721,704 filed Nov. 2, 2012 entitled “Discovering Brands and Sizes,” the content of which is incorporated herein by reference in its entirety.

### TECHNICAL FIELD

The present application relates generally to systems and methods to facilitate determination of physical fit of items offered in an online marketplace on users.

### BACKGROUND

An electronic marketplace offers a large number of items for sale. It is not uncommon for some electronic marketplaces to offer upwards of hundreds of thousands or millions of items for sale. Each item to be offered for sale is submitted to the electronic marketplace, the submission including information about the item such as an item name, item description, and item image. If the item is associated with a recognizable manufacturer, distributor, or otherwise a source—the item being a brand name item—such source or brand name information may be submitted to the electronic marketplace. Many items can be articles of clothing, footwear, accessories, or other items that are meant to be worn by persons. Due to differences in size and body shapes across the population, items meant to be worn by persons are offered in more than one size.

For items meant to be worn, it is necessary to select the correct size of an item of interest so that the item will fit when worn (by the buyer or intended recipient). In physical stores this entails trying on one or more sizes of the item of interest to determine fit. In electronic marketplaces, a standardized size chart is typically provided for potential buyers to choose the appropriate size. However, even standardized size charts do not accurately reflect the physical fit of the item due to differences in body shape (e.g., flat vs. big belly, rounded hips vs. flat hips, long legs relative to body vs. short) and item styles among brands and sometimes even within different product lines of a given brand (e.g., loose fit line vs. tight fit). For example, a first pair of dress pants by brand X may fit a given person in a size 12 while the second pair of pants also by brand X in a different style (e.g., casual/baggy style) may fit the same person in a size 10. The size variance is likely even greater among items across different categories (e.g., pants vs. shirts vs. shoes) or different brands. Thus, whether an item in a certain size will physically fit a particular person cannot be readily ascertained and is what typically leads buyers to physically try on items they have never worn even if they believe they know their own size or even if they have other items from the same brand. However, if they have already bought items of a certain brand, model, style, and size that fit well they are generally more inclined to buy such items without trying them on again since they are confident of good fit.

Such variations, and thus uncertainty in the correct size of items meant to be worn, discourage purchases in electronic marketplaces. Even when purchases are made, the rate of returns, exchanges, resale, and/or customer dissatisfaction may be higher for items meant to be worn in general due to sizing uncertainty or mismatch.

### BRIEF DESCRIPTION OF THE DRAWINGS

Some embodiments are illustrated by way of example and not limitations in the figures of the accompanying drawings, in which:

FIG. 1 illustrates a network diagram depicting an example system for facilitating automatic determination of proper physical fit of items according to some embodiments.

FIG. 2 illustrates a block diagram of additional details of the example system of FIG. 1 according to some embodiments.

FIG. 3 illustrates a block diagram showing automatic determination of proper physical fit of items implemented in modules according to some embodiments.

FIGS. 4A-4C illustrate a flow diagram showing physical fit predictive functionalities or operations implemented by the modules of FIG. 3 according to some embodiments.

FIG. 5 illustrates a diagrammatic representation of a machine in the example form of a computer system within which a set of instructions, for causing the machine to perform any one or more of the methodologies of FIGS. 2-4C according to some embodiments.

The headings provided herein are for convenience only and do not necessarily affect the scope or meaning of the terms used.

### DETAILED DESCRIPTION

Described in detail herein is an apparatus and method for automatically determining which wearable items are likely to properly fit a user without use of the user's body measurements, items' measurements, and/or the user's preferred fit or style preferences. In one embodiment, item purchase history is mined for a plurality of users. A first buyer who has purchased at least a minimum number of the same wearable items as a second buyer is deemed to have the same physical fit as the second buyer for wearable items in the same item category as the same/common wearable items. Based on the assumption of same (or nearly the same) physical fit for a given item category between the first and second buyers, other wearable item purchases in the same given item category by the first buyer are likely fit the second buyer and vice versa. Filtering is applied to the items purchased by the first and second buyers to exclude purchases that are intended for other users or are indicative of improper fit. The “other” wearable items in the same item category likely to fit the other buyer are provided to such buyer in a variety of formats.

The following description is presented to enable any person skilled in the art to create and use a computer system configuration and related method and article of manufacture to determine and use true fit alternatives in an electronic commerce environment. Various modifications to the example embodiments will be readily apparent to those skilled in the art, and the generic principles defined herein may be applied to other embodiments and applications without departing from the scope of the invention. Moreover, in the following description, numerous details are set forth for the purpose of explanation. However, one of ordinary skill in the art will realize that the invention may be practiced without the use of these specific details. In other instances, well-known structures and processes are not shown in block diagram form in order not to obscure the description of the invention with unnecessary detail. Thus, the present disclosure is not intended to be limited to the embodiments shown, but is to be accorded the widest scope consistent with the principles and features disclosed herein.

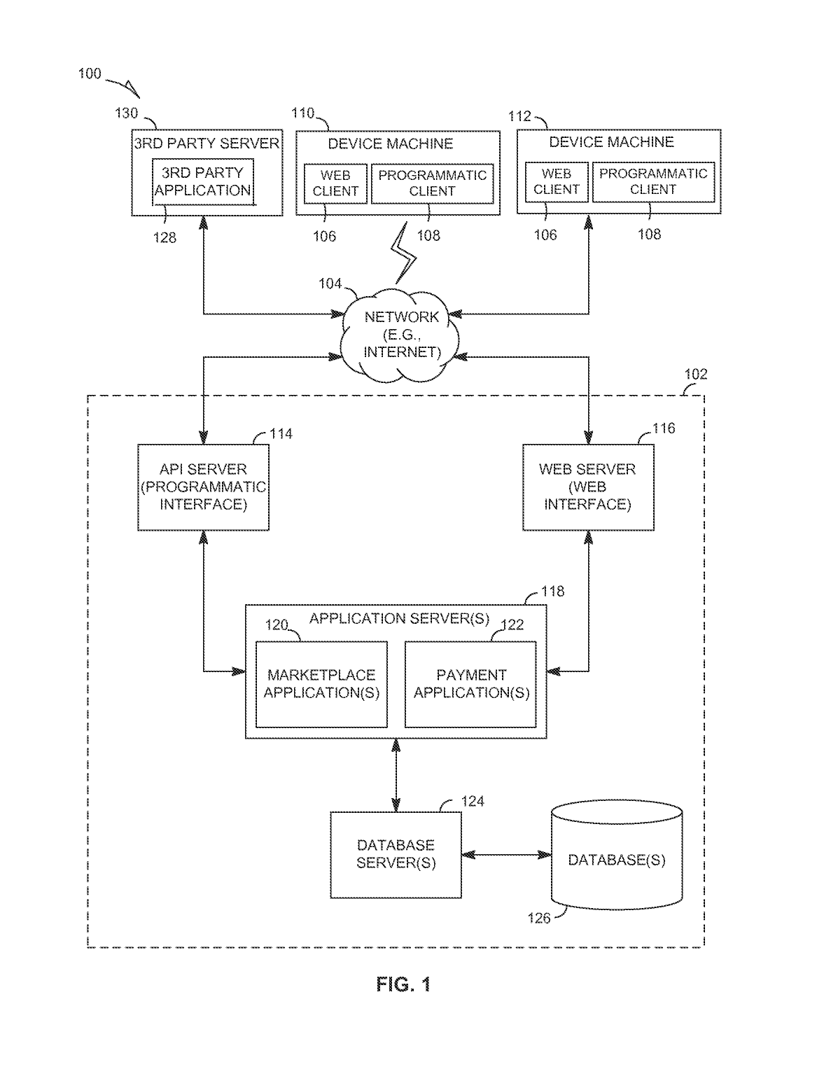

FIG. 1 illustrates a network diagram depicting an example system 100 to facilitate automatic determination of proper physical fit of certain goods or products that are made in a plurality of sizes and which are meant to be worn by persons for a given user in an electronic commerce (e-commerce), electronic marketplace, and/or online marketplace environment according to some embodiments. Goods or products that are made in a plurality of sizes and which are meant to be worn by persons include, but are not limited to, articles of clothing, footwear, headwear, accessories, and the like (collectively referred to as items meant to be worn, wearable items, different sized items, or items). Once the proper physical fit of a given item on a given user is determined, the fit information can be used to automatically identify the correct size of other items for the given user. This and other uses of the fit information are described in detail below.

A networked system 102 forms a network-based publication system that provides server-side functionality, via a network 104 (e.g., the Internet or Wide Area Network (WAN)), to one or more clients and devices. FIG. 1 further illustrates, for example, one or both of a web client 106 (e.g., a web browser) and a programmatic client 108 executing on device machines 110 and 112. In one embodiment, the publication system 100 comprises a marketplace system. In another embodiment, the publication system 100 comprises other types of systems such as, but not limited to, a social networking system, a matching system, an electronic commerce (e-commerce) system, and the like.

Each of the device machines 110, 112 comprises a computing device that includes at least a display and communication capabilities with the network 104 to access the networked system 102. The device machines 110, 112 comprise, but are not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, game consoles, set-top boxes, network PCs, mini-computers, and the like. Each of the client machines 110, 112 may connect with the network 104 via a wired or wireless connection. For example, one or more portions of network 104 may be an ad hoc network, an intranet, extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each of the device machines 110, 112 includes one or more applications (also referred to as “apps”) such as, but not limited to, a web browser, messaging application, electronic mail (email) application, an e-commerce site application (also referred to as a marketplace application), and the like. In some embodiments, if the e-commerce site application is included in a given one of the device machines 110, 112, then this application is configured to locally provide the user interface and at least some of the functionalities with the application configured to communicate with the networked system 102, on an as needed basis, for data and/or processing capabilities not locally available (such as access to a database of items available for sale, to authenticate a user, to verify a method of payment, etc.). Conversely if the e-commerce site application is not included in a given one of the device machines 110, 112, the given one of the device machines 110, 112 may use its web browser to access the e-commerce site (or a variant thereof) hosted on the networked system 102. Although two device machines 110, 112 are shown in FIG. 1, more or less than two device machines can be included in the system 100.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of e-commerce functions and services to users that access networked system 102. E-commerce functions/services may include a number of publisher functions and services (e.g., searching, listing, content viewing, payment, etc.). For example, the marketplace applications 120 may provide a number of services and functions to users for listing goods and/or services or offers for goods and/or services for sale, searching for goods and services, facilitating transactions, and reviewing and providing feedback about transactions and associated users. Additionally, the marketplace applications 120 may track and store data and metadata relating to listings, transactions, and user interactions. In some embodiments, the marketplace applications 120 may publish or otherwise provide access to content items stored in application servers 118 or databases 126 accessible to the application servers 118 and/or the database servers 124. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products or items (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102. In other embodiments, the payment applications 122 may be omitted from the system 100. In some embodiments, at least a portion of the marketplace applications 120 may be provided on the device machines 110 and/or 112.

Further, while the system 100 shown in FIG. 1 employs a client-server architecture, embodiments of the present disclosure is not limited to such an architecture, and may equally well find application in, for example, a distributed or peer-to-peer architecture system. The various marketplace and payment applications 120 and 122 may also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

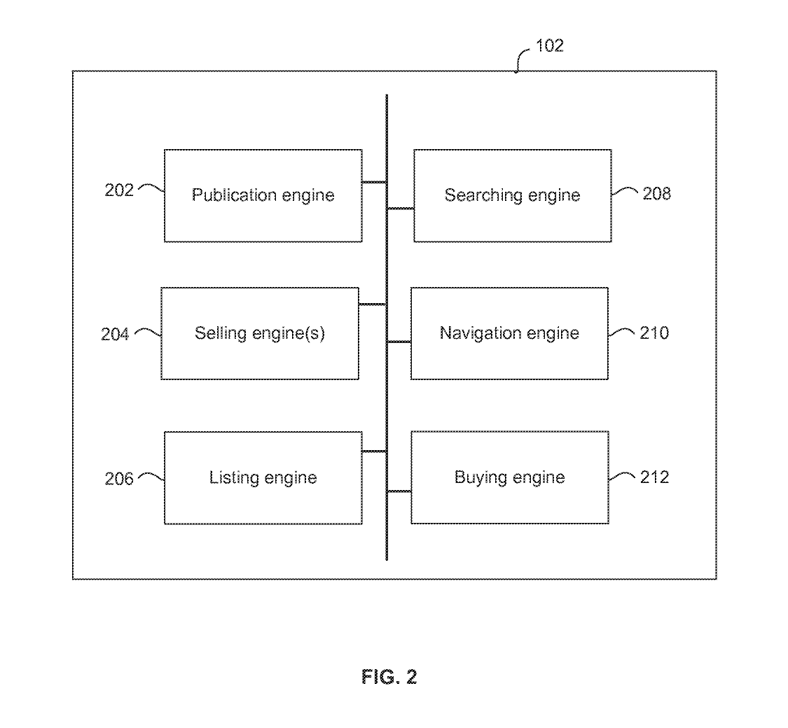

FIG. 2 illustrates a block diagram showing components provided within the networked system 102 according to some embodiments. The networked system 102 may be hosted on dedicated or shared server machines (not shown) that are communicatively coupled to enable communications between server machines. The components themselves are communicatively coupled (e.g., via appropriate interfaces) to each other and to various data sources, so as to allow information to be passed between the applications or so as to allow the applications to share and access common data. Furthermore, the components may access one or more databases 126 via the data servers 128.

The networked system 102 may provide a number of publishing, listing, and/or price-setting mechanisms whereby a seller (also referred to as a first user) may list (or publish information concerning) goods or services for sale or barter, a buyer (also referred to as a second user) can express interest in or indicate a desire to purchase or barter such goods or services, and a transaction (such as a trade or purchase) may be completed pertaining to the goods or services. To this end, the networked system 102 may comprise at least one publication engine 202 and one or more selling engines 204. The publication engine 202 may publish information, such as item listings or product description pages, on the networked system 102. In some embodiments, the selling engines 204 may comprise one or more fixed-price engines that support fixed-price listing and price setting mechanisms and one or more auction engines that support auction-format listing and price setting mechanisms (e.g., English, Dutch, Chinese, Double, Reverse auctions, etc.). The various auction engines may also provide a number of features in support of these auction-format listings, such as a reserve price feature whereby a seller may specify a reserve price in connection with a listing and a proxy-bidding feature whereby a bidder may invoke automated proxy bidding. The selling engines 204 may further comprise one or more deal engines that support merchant-generated offers for products and services.

A listing engine 206 allows sellers to conveniently author listings of items or authors to author publications. In one embodiment, the listings pertain to goods or services that a user (e.g., a seller) wishes to transact via the networked system 102. In some embodiments, the listings may be an offer, deal, coupon, or discount for the good or service. Each good or service is associated with a particular category. The listing engine 206 may receive listing data such as title, description, and aspect name/value pairs. Furthermore, each listing for a good or service may be assigned an item identifier. In other embodiments, a user may create a listing that is an advertisement or other form of information publication. The listing information may then be stored to one or more storage devices coupled to the networked system 102 (e.g., databases 126). Listings also may comprise product description pages that display a product and information (e.g., product title, specifications, and reviews) associated with the product. In some embodiments, the product description page may include an aggregation of item listings that correspond to the product described on the product description page.

The listing engine 206 also may allow buyers to conveniently author listings or requests for items desired to be purchased. In some embodiments, the listings may pertain to goods or services that a user (e.g., a buyer) wishes to transact via the networked system 102. Each good or service is associated with a particular category. The listing engine 206 may receive as much or as little listing data, such as title, description, and aspect name/value pairs, that the buyer is aware of about the requested item. In some embodiments, the listing engine 206 may parse the buyer's submitted item information and may complete incomplete portions of the listing. For example, if the buyer provides a brief description of a requested item, the listing engine 206 may parse the description, extract key terms and use those terms to make a determination of the identity of the item. Using the determined item identity, the listing engine 206 may retrieve additional item details for inclusion in the buyer item request. In some embodiments, the listing engine 206 may assign an item identifier to each listing for a good or service.

In some embodiments, the listing engine 206 allows sellers to generate offers for discounts on products or services. The listing engine 206 may receive listing data, such as the product or service being offered, a price and/or discount for the product or service, a time period for which the over is valid, and so forth. In some embodiments, the listing engine 206 permits sellers to generate offers from the sellers' mobile devices. The generated offers may be uploaded to the networked system 102 for storage and tracking.

Searching the networked system 102 is facilitated by a searching engine 208. For example, the searching engine 208 enables keyword queries of listings published via the networked system 102. In example embodiments, the searching engine 208 receives the keyword queries from a device of a user and conducts a review of the storage device storing the listing information. The review will enable compilation of a result set of listings that may be sorted and returned to the client device (e.g., device machine 110, 112) of the user. The searching engine 308 may record the query (e.g., keywords) and any subsequent user actions and behaviors (e.g., navigations).

The searching engine 208 also may perform a search based on the location of the user. A user may access the searching engine 208 via a mobile device and generate a search query. Using the search query and the user's location, the searching engine 208 may return relevant search results for products, services, offers, auctions, and so forth to the user. The searching engine 208 may identify relevant search results both in a list form and graphically on a map. Selection of a graphical indicator on the map may provide additional details regarding the selected search result. In some embodiments, the user may specify as part of the search query a radius or distance from the user's current location to limit search results.

The searching engine 208 also may perform a search based on an image. The image may be taken from a camera or imaging component of a client device or may be accessed from storage.

In a further example, a navigation engine 210 allows users to navigate through various categories, catalogs, or inventory data structures according to which listings may be classified within the networked system 102. For example, the navigation engine 210 allows a user to successively navigate down a category tree comprising a hierarchy of categories (e.g., the category tree structure) until a particular set of listing is reached. Various other navigation applications within the navigation engine 210 may be provided to supplement the searching and browsing applications. The navigation engine 210 may record the various user actions (e.g., clicks) performed by the user in order to navigate down the category tree.

The buying engine 212 facilitates one or more buyers to purchase goods or services offered by the networked system 102. The buying engine 212 may provide a user interface to receive indications of goods or services to be purchased, billing information, shipping information, shipping preferences, and the like for a buyer to initiate and complete a purchase of goods or services of interest.

Additional modules and engines associated with the networked system 102 are described below in further detail. It should be appreciated that modules or engines may embody various aspects of the details described below.

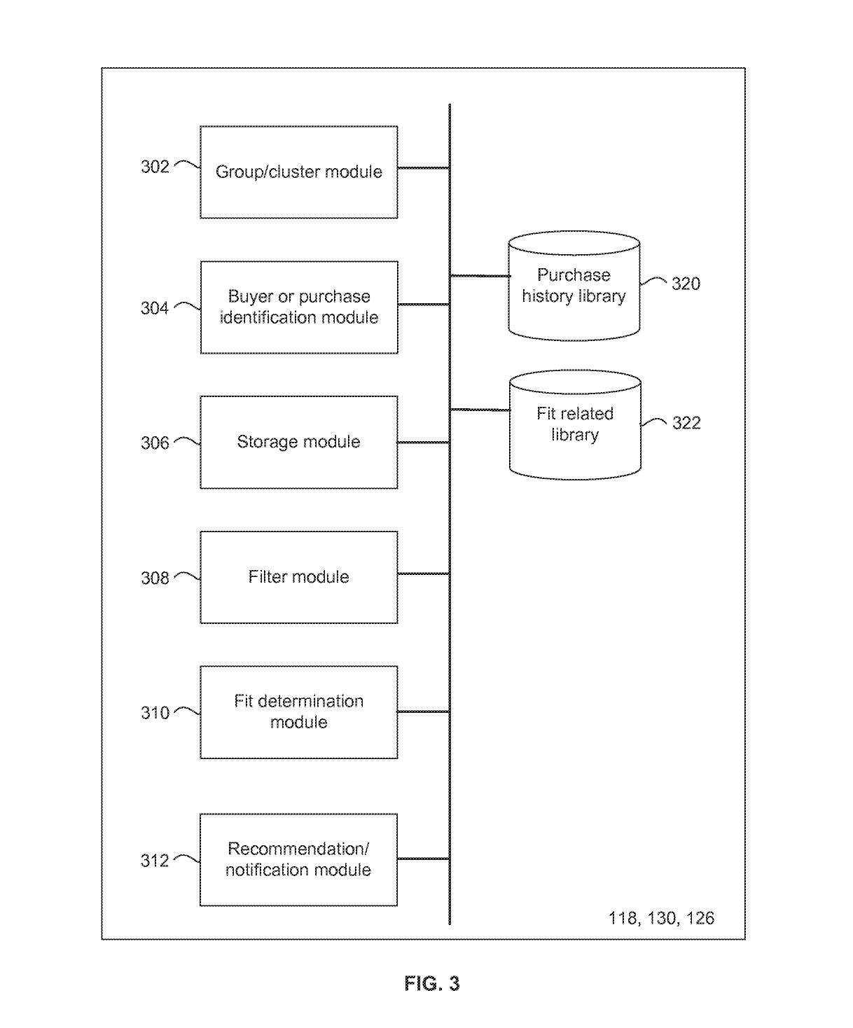

FIG. 3 illustrates a block diagram showing proper physical fit determination and usage for e-commerce or marketplace implemented in modules and libraries/data structures/databases according to some embodiments. The modules comprise one or more software components, programs, applications, apps, or other units of code base or instructions configured to be executed by one or more processors included in the application servers 118 and/or third party server 130. The modules include a group/cluster module 302, a buyer or purchase identification module 304, a storage module 306, a filter module 308, a fit determination module 310, and a recommendation/notification module 312. The modules 302-312 can communication with each of a purchase history library 320 and a fit related library 322, in which libraries 320, 322 may be included in databases 126. Although modules 302-312 are shown as distinct modules in FIG. 3, it should be understood that modules 302-312 may be implemented as fewer or more modules than illustrated. It should also be understood that any of modules 302-312 may communicate with one or more components included in the system 100, such as database servers 124, application servers 118, third party server 130, device machine 110, or device machine 112. Similarly, libraries 320 and 322 are shown as distinct libraries in FIG. 3. However, it is understood that the content of libraries 320, 322 may be stored in fewer or more libraries than illustrated.

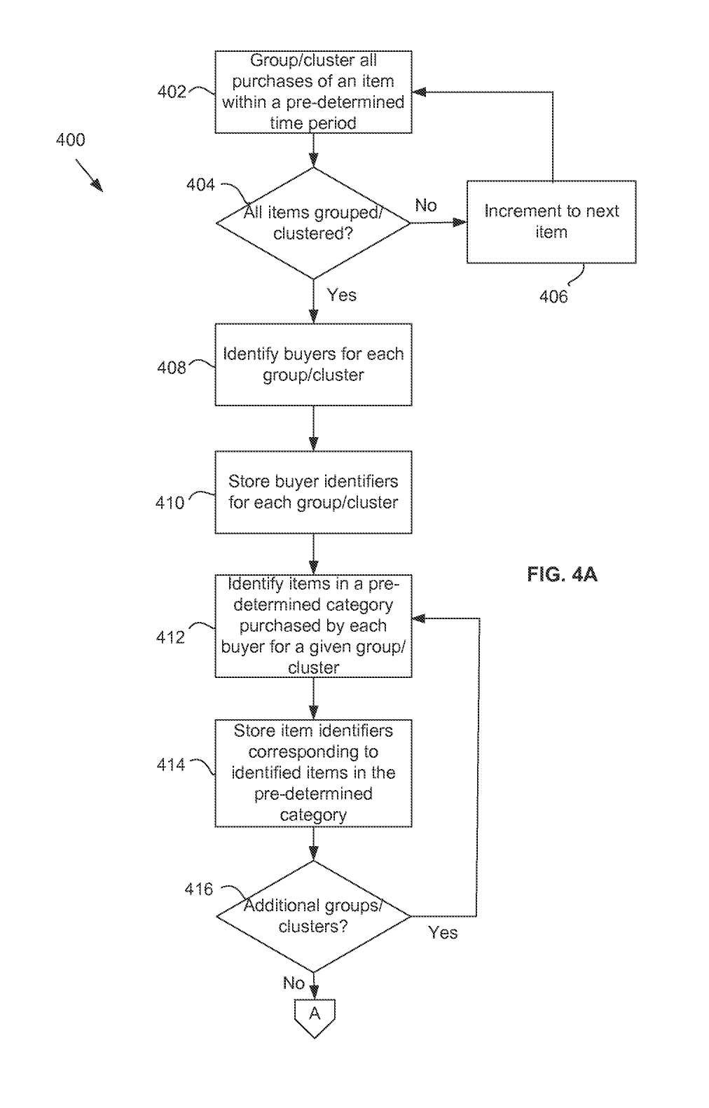

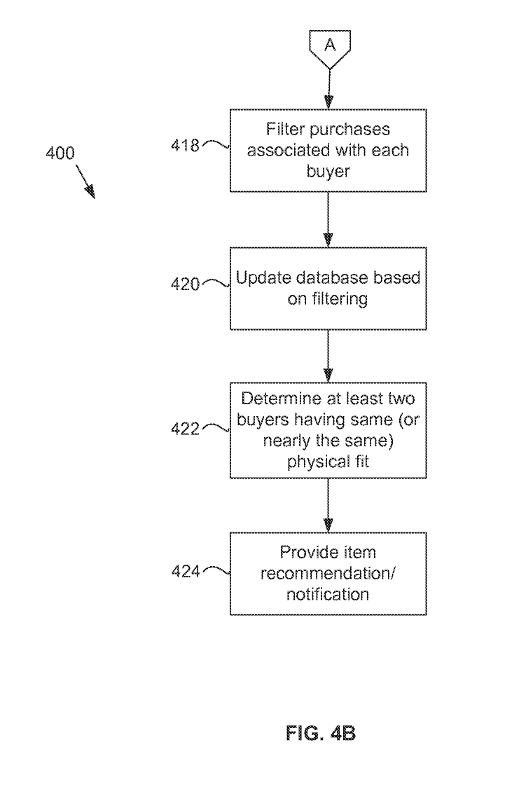

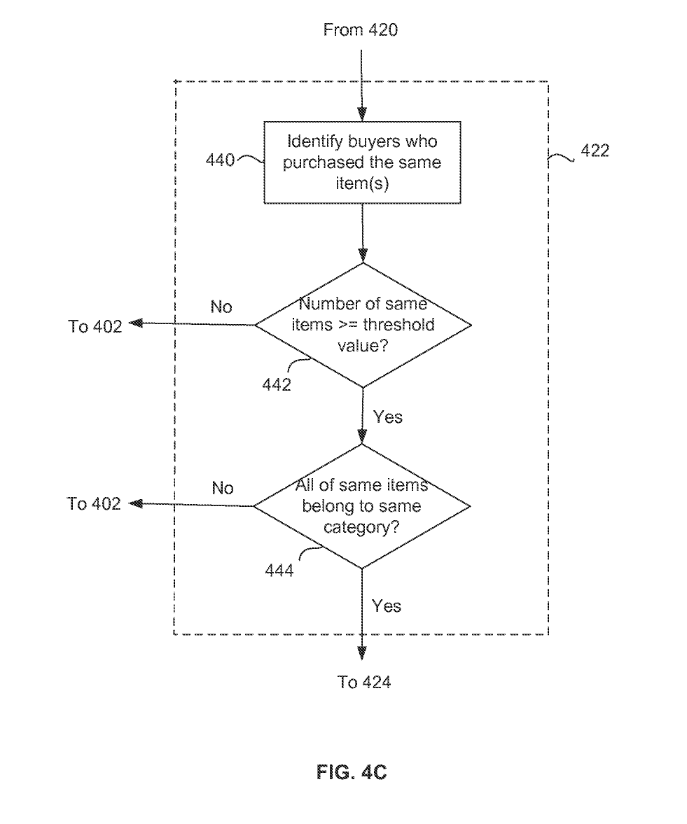

FIGS. 4A-4C illustrate a flow diagram 400 showing physical fit determination and usage functionalities or operations implemented by the modules of FIG. 3 according to some embodiments. The functionalities implemented by flow diagram 400 provide automatic determination of proper physical fit of specific categories of wearable items for one or more users based on commonality of purchase history among users. Proper physical fit is identifiable without knowing or use of users' body measurements, dimensions of the wearable items, and/or users' preferences for type of fit (e.g., fit close to body, semi-fit to body, loose-fit to body, etc.). Once a group of users is determined to have the same (or nearly the same) physical tit for a category of items (e.g., shoes, dress shoes, jeans, shirts, dresses, etc.), it may be assumed that the exact items purchased by any members of such a group (e.g., including the size purchased) will fit the other members of the group and thus suitable for sharing within the group. In other words, it is possible to virtually aggregate (at least a select portion of) the “closets” of members of such a group for purposes of automatically identifying other items (down to the brand, model, style, and size of each item) that are likely to properly fit all members of such a group. Proper physical fit is also referred to as true fit or true fitment. The operations of flow diagram 400 can be performed by a server included in the networked system 102 (e.g., API server 114, web server 116, or application servers 118) and/or third party server 130.

At a block 402, the group/cluster module 302 is configured to mine the purchase history library 320 to obtain and group/cluster purchases of a given wearable item within a pre-determined time period. The given wearable item comprises a uniquely identifiable item such as, but not limited to, a unique brand/model/style/size (BMSS) combination of an item that can be worn by a person or taxonomy of clothing, shoes, or accessories. As an example, Levi Strauss mid-rise skinny jeans in dark rinse in a size 10 would be considered a different item from Levi Strauss mid-rise skinny jeans in dark rinse in a size 12. The pre-determined time period can be any time period such as one day, one week, one month, six months, one year, two years, five years, or the like. The pre-determined time period may be selected depending on the amount of available data, processing capabilities, frequency of data mining, first introduction date of the item, and/or other determination of relevant time period. The purchase history library 320 includes purchase history data for one or more e-commerce or electronic marketplace. The purchase history library 320 may also include purchase history data from physical stores and/or sellers that facilitate purchasing transactions outside of the e-commerce or electronic marketplace network.

Next at a block 404, a check is performed as to whether all of the plurality of unique wearable items has been grouped/clustered. If there is at least one unique wearable item for which purchases have not been grouped/clustered together, flow diagram 400 increments to the next uniquely wearable item (block 406) and block 402 is performed for such item. In some embodiments, the pre-determined time period in block 402 is the same across the plurality of unique wearable items. In other embodiments, the pre-determined time period in block 402 can be different for one or more items compared to other items. As an example, if item A is a new item offered for sale only within the last six months while item B has been offered for sale for the last two years, the time period during which items A and B may be purchased would be different from each other. In still other embodiments, the pre-determined time period is selected to be a time frame/slot within which the wearer's body dimensions are likely to remain constant or nearly constant. For example, if the item is an infant's garment, then the pre-determined time period may be in six month increments while an adult's garment may be better suited for five year increments. Within that time slot the maximum number of data points possible may be sought.

Once purchases for each unique wearable item have been grouped/clustered, flow diagram 400 proceeds to block 408. The buyer or purchase identification module 304 (also referred to as the identification module 304) is configured to identify all the buyers for each group/cluster. Identification of buyers can comprise identification of at least a unique buyer identifier for each different buyer. Examples of buyer identifiers include, but are not limited to, user names, email addresses, or other unique differentiator between buyers. Buyer identifier or identification data are included in the purchase history library 320 (e.g., each purchase includes information such as the date and time of purchase, item(s) purchased, buyer identifier, purchase amount, method of payment, shipping address, and the like).

The storage module 306 then stores the identification of the buyers for each group/cluster in the fit related library 322 (block 410). Alternatively the buyer identification for each group/cluster may be stored, pointed to, or otherwise organized in the purchase history library 320.

At a block 412, the identification module 306 is configured to identify all (other) unique wearable items in a pre-determined item category that are purchased by each buyer for a given group/cluster identified in block 408. The purchases can be those made within a pre-set time period, the pre-set time period being the same or different from the pre-determined time period of block 402. The pre-determined item category (also referred to as the pre-determined category or item category) is in accordance with the unique wearable item (e.g., per group/cluster) corresponding to each buyer. A given unique wearable item may be classified within one or more pre-determined item categories. For example, assume a given buyer purchased a particular BMSS running shoe. The running shoe may belong within the following categories: running shoes, shoes, athletic shoes, casual shoes, cushioned shoes, footwear, and/or comfortable shoes. The identification module 306 may thus identify all of the other unique wearable items purchased by the given buyer that are also classified as running shoes, shoes, athletic shoes, casual shoes, cushioned shoes, footwear, and/or comfortable shoes. If the given buyer purchased particular BMSS tennis shoes, hiking shoes, or loafers within the prescribed time period, such shoes would be identified as an “other” purchase to the running shoes purchased by the given buyer. For a given unique wearable item for a given buyer, zero, one or more items purchased in the pre-determined item category can be identified.

The selection of the pre-determined item category(ies) can be narrow or wide, depending on the extent of purchase history data, how narrowly items are categorized on the e-commerce site, industry standards or norms on related or substitute “wearable” categories or categories that buyers would consider reasonable substitutes for a given type of wearable item (e.g., this can be discovered by looking at trends of buyers who search for a certain set of keywords and end up engaging such as viewing, bidding, placing on wish lists, or buying items across different sub-categories during a given session). In the running shoes example above, the pre-determined item category may be selected to be athletic shoes based on the assumption that the physical fit of athletic shoes are more likely to be similar to each other than with all types of shoes in general. Conversely, if there is confidence that the physical fit of casual shoes in general can be automatically determined based on fit of running shoes, then the pre-determined item category may be casual shoes. Another example may be aggregating results across several sub-categories like running, hiking, and walking shoes as a more narrow search where fit across the sub-categories is very likely to be similar.

The storage module 306 stores the “other” purchases identified in block 412 in the fit related library 322 for each buyer (block 414). The stored information includes, but not limited to, item identifiers and/or BMSS level of information of the “other” purchases in association with the buyer, item and/or pre-determined item category. Identification of “other” purchases in the pre-determined category for each buyer of each group/cluster is repeated (yes branch of block 416) until all the groups/clusters of block 402 have been addressed. Note that the particular pre-determined item category used for a given group/cluster depends upon the item associated with the given group/cluster. As such, the pre-determined item category across different groups/clusters may be the same or different from each other. Continuing the above example, the buyer that purchased particular BMSS running shoes may have also purchased a particular BMSS shirt. In which case the corresponding pre-determined item categories may be shirts, sweaters, and/or coats with respect to the BMSS shirt.

Next at a block 418, the filter module 308 is configured to filter the wearable item purchases associated with each buyer (stored in the fit related library 322) to account for outlier purchases that should not be attributable to the given buyer. For each buyer, each unique wearable item upon which the groups/clusters were formed (also referred to as a start, initial, or reference item) as well as the “other” purchases in the pre-determined item categories corresponding to the buyer's respective unique wearable items (collectively referred to as buyer associated items) is filtered. Outlier events include, but are not limited to, any of the buyer associated items being returned; re-sold within a pre-determined time period (e.g., listed for resale within one month); purchased as a gift for another person (e.g., can be identified if shipping address is different or if the item is for the opposite gender than most other items purchased); deviate in size or style more than a threshold amount from the buyer's other (recent) purchases; or otherwise indicative of not being intended for the buyer or not a good physical fit on the buyer. As an example, when analyzing a re-sale of an item, the filter module 308 can factor in the listing description regarding the condition of the item such as “like new,” “new with tags,” “used,” “lightly used,” etc. to ascertain the reason for the resale. An item listed as being new with the tags on may indicate that the item is being sold because it doesn't fit (e.g., never worn), while an item listed as being used or lightly used may indicate that the item fits but is being sold to free up space or money to buy other items. As another example, if an item is a luxury or expensive item, this is taken into account because such items tend to be resold (even if it fits the buyer) before it becomes too old to trade up or loses its resale value. The filter module 308 can further be tuned to weight the examples above (e.g., new item resold with tags or luxury item) higher than other signals about the true fit dimensions of the buyer—consequently providing even higher confidence that other items that deviate significantly from this mean were not meant for this buyer (e.g., gifts or purchases for other family and friends).

Any item associated with a buyer determined to be an outlier is filtered out or disassociated from the buyer in the fit related library 322. The fit related library 322 is accordingly updated by the storage module 306 at a block 420.

Although the filtering of outlier item purchases is shown in flow diagram 400 as being performed after the “other” purchases are identified in block 412, it is contemplated that block 418 can be applied before block 412 (to filter out reference item(s) for each buyer that are deemed not to fit the respective buyer before identification of the buyer's “other” purchases) and after block 412 (to fitter out “other” item purchases for each buyer that are deemed not to fit the respective buyer).

Using the filtered data in the fit related library 322, the fit determination module 310 is configured to automatically determine at least two buyers that have the same (or nearly the same) physical fit with each other for a given item category (block 422). FIG. 4C illustrates additional details of block 422 according to some embodiments. At a sub-block 440, the fit determination module 310 is configured to identify all buyers who purchased the same item(s) (e.g., same BMSS item). If the number of same or common items among the identified buyers is less than a threshold value (no branch of sub-block 442), then the flow diagram 400 returns to block 402 to mine the latest purchase data. The threshold value comprises a pre-determined value such as, but not limited to, one, two, three, five, ten, or any other value sufficient to establish confidence that the identified buyers have the same or nearly the same physical fit. Typically the greater the number of matches, the greater the confidence in the inferences or assumptions made based on the matches.

When the number of same or common items among the identified buyers equals or exceeds the threshold value (yes branch of sub-block 442), then the fit determination module 310 confirms that the same or common items belong to the same item category at a sub-block 444. If the items are from disparate categories relative to each other (no branch of sub-block 444), then the flow diagram 400 returns to block 402 to continue mining the latest purchase data. Otherwise the items are classified within the same category (yes branch of sub-block 444) and the identified buyers are deemed to have the same (or nearly the same) physical fit for items in the given category.

It is assumed that all buyers who have purchased the same unique item(s) (e.g., a particular BMSS combination item) (and met the minimum threshold for number of same items between this set of buyers) have the same physical fit among themselves for the item category corresponding to the common item(s). Finding a group of persons having the same or nearly the same physical fit for a given item category is also referred to as determination of true fit or true fitment. In some embodiments, a finding of true fit serves as a proxy for knowing certain buyer characteristics without having to actively engage or solicit information from the buyers. Buyer characteristics that may be assumed include, but are not limited to: (1) body measurements relevant to the item category associated with the common item(s) are the same (or nearly the same) for all buyers within the identified buyer set (e.g., if the item category is shoes, then feet measurements are the relevant body measurements vs. if the item category is shirts, the chest, waist, shoulder, and arm measurements are relevant instead of feet dimensions); (2) amount of preferred spacing between relevant body parts and items in the particular item category are the same (or nearly the same) for all buyers within the identified buyer set (e.g., fitted to body, semi-fitted to body, loose fit to body, etc.); and/or (3) similar taste in style or how the wearable item looks or hangs on the buyer's body among the identified buyer set.

Accordingly all of the “other” item purchases within the same given item category (excluding those filtered out in block 418) by the identified buyer set can be “shared” among all the buyers within the identified buyer set, because there is good probability that these “other” purchases will also fit the buyers within the identified buyer set. Conceptually the closets of all the buyers who share a common fit or affinity for a particular item (to the granularity of a particular BMSS combination) are aggregated so that such buyers' other closet items can serve as true fit alternatives for the other respective buyers within the identified buyer set. For example, buyer A and buyer B both bought the same BMSS running shoes. Each of buyers A and B are also likely to have purchased other shoes in particular BMSS combinations tennis shoes, hiking shoes, etc. it is likely that if buyer A borrowed buyer B's particular BMSS tennis shoes, those shoes would fit buyer A. Thus, buyer A's particular BMSS tennis shoes may be recommended to buyer A as a true fit alternative based on both buyers A and B having a matching BMSS running shoe purchase.

Returning to block 424 in FIG. 4B, the recommendation/notification module 312 is configured to provide some form of sharing of the “other” items of the same given item category made by the identified buyer set among all the buyers within the identified buyer set using the data stored in the fit related library 322. In some embodiments, a given buyer's own “other” items may not be provided to him or herself since such purchases are already known by the given buyer. Sharing can be automatic (e.g., pushed periodically or as matches are determined) or in response to buyer-initiated activity (e.g., user initiates a product search, views product information, logs in, or shows interest in a product). Sharing can be provided in one or more plurality of formats such as, but not limited to, electronic mail (email), text message, banner advertisement, in an application (app), a website, or implicitly by limiting search results based on “fit” characteristics applied to the relevant categories thus returning only results that are a “true fit” for the buyer. An example of limiting search results based on fit characteristics comprises providing only size 9 search results across the shoes category for any queries involving shoes if the buyer has logged in and a set of true fit recommendations exist for the buyer. There is also a way to take the “true fitment” recommendations developed on one e-commerce site and leverage them on other sites through a browser widget that can act as an overlay tool when searching through other sites that is able to flag “true fit” items on other sites by tapping into the purchase and fit libraries whenever the buyer interacts with a product or item page on another site that can be matched to an item in the original e-commerce site where true fit was discovered.

The recommendation/notification module 312 is configured to package (or facilitate packaging) the “other” items recommendation or notification to respective buyer(s) and transmit (or facilitate transmission) to one or more devices associated with the respective buyer(s). Examples of recipient devices associated with the respective buyer(s) include, but are not limited to, device machines 110 or 112. Note that the item recommendation (also referred to as a notification or suggestion) includes recommendation of a specific size of the item from among a plurality of sizes of the item.

An example of item groups/clusters is shown below, in which one matching unique wearable item among buyers is deemed sufficient to indicate the same or nearly the same physical fit between such buyers (threshold value=1).

| Item A | Item B |
|---|---|
| Buyer 1 (item C*, item D*) | Buyer 1 |
| Buyer 2 (item E) | Buyer 2 |
| Buyer 3 (item F*) | Buyer 10 |
| Buyer 4 (item G*, item H) | Buyer 11 |
| Buyer 5 (item I) | Buyer 15 |

*Denotes same item category as that of item A

All of the buyers of item A (Buyers 1, 2, 3, 4, and 5) are deemed to have the same or nearly the same physical fit as each other for the item category corresponding to item A. The items listed in parentheses comprise the “other” item purchases identified in block 412. Items C, D, F, and G are classified in the same item category as item A. The remaining “other” items (items E, H, and I) are classified in one or more different item categories from item A. Thus, items C, D, F, and G (each of these items being a particular BMSS combination) represent true fit alternatives of item A, and can be recommended to Buyers 1, 2, 3, 4, and 5.

Another example of item groups/cluster is shown below, in which at least two buyers are required to have at least two matching unique wearable items in the same item category (threshold value=2).

| Item A | Item B | Item C |
|---|---|---|
| Buyer 1 | Buyer 1 | Buyer 200 |
| Buyer 2 | Buyer 101 | Buyer 1 |
| Buyer 3 | Buyer 102 | Buyer 2 |
| . . . | . . . | Buyer 3 |
| | | . . . |

Buyers 1, 2, and 3 have items A and C in common. Assuming items A and C are classified in the same item category, “other” items purchased by buyers 1, 2, and 3 that are also in the same item category as that of items A and C are potential true fit alternatives among buyers 1, 2, and 3. Furthermore, assuming item B also belongs to the same category as items A and C, then one could conclude that buyers 2 and 3 may also find item B a true fit for them given that buyer 1 owns both item B as well as items A and C in common with them.

In this manner, proper fit of certain unique wearable items (particular BMSS combination) on particular users is predicted based on commonality of purchases of unique wearable items by particular users. In providing true fitment alternatives to particular users, the item recommendations are granular including identification of a particular size from among a plurality of sizes offered for sale, the brand, model, and style of the items. The automatic physical fit determination scheme disclosed herein is capable of automatically identifying other unique wearable items that are likely to be a good fit (physical fit, style fit, fit preference) for a particular user without expressly knowing the particular user's body measurements, the unique wearable items' dimensions, or the particular user's fit or style preferences.

The scheme is configured to automatically determine a level of item granularity (e.g., item size) suitable for a particular user that the user cannot obtain from product reviews. Item recommendations are customized and personalized for each user of an e-commerce or electronic marketplace system, thereby improving the user experience (e.g., the user doesn't have to guess at his or her correct size) and increasing the chance that the user will act on the recommendation. The physical fit determined for each user is dynamic and kept current due to the continual stream of purchases from a plurality of users that are mined for applicability to certain groups of users. The scheme functions like crowd sourcing without the need for anyone to actively participate or provide input.

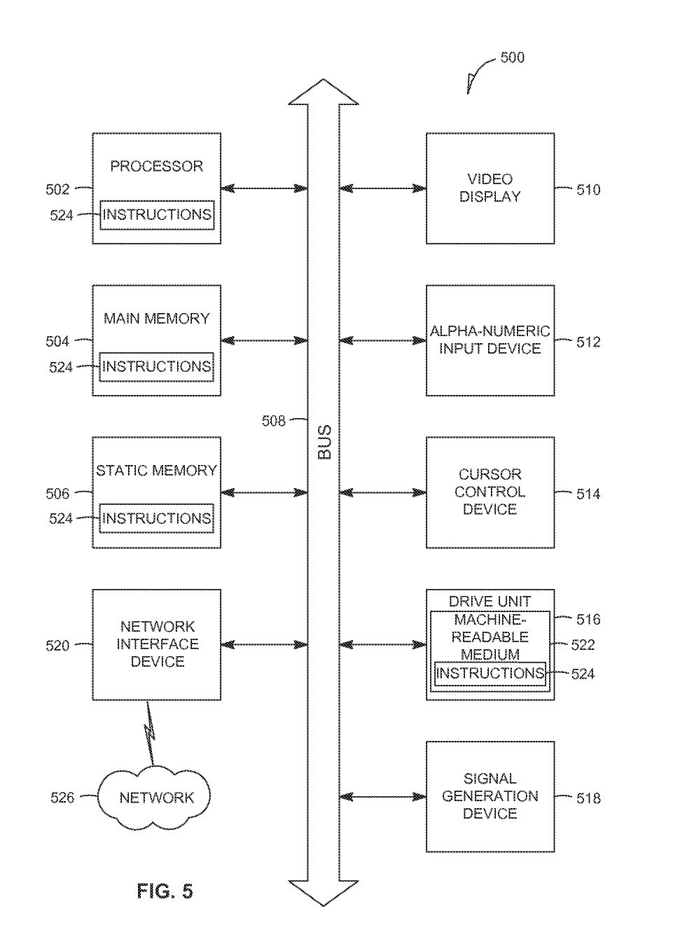

FIG. 5 shows a diagrammatic representation of a machine in the example form of a computer system 500 within which a set of instructions, for causing the machine to perform any one or more of the methodologies discussed herein, may be executed. The computer system 500 comprises, for example, any of the device machine 110, device machine 112, applications servers 118, API server 114, web server 116, database servers 124, or third party server 130. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet, a set-top box (STB), a Personal Digital Assistant (PDA), a smart phone, a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU), or both), a main memory 504 and a static memory 506, which communicate with each other via a bus 508. The computer system 500 may further include a video display unit 510 (e.g., liquid crystal display (LCD), organic light emitting diode (OLED), touch screen, or a cathode ray tube (CRT)). The computer system 500 also includes an alphanumeric input device 512 (e.g., a physical or virtual keyboard), a cursor control device 514 (e,g., a mouse, a touch screen, a touchpad, a trackball, a trackpad), a disk drive unit 516, a signal generation device 518 (e.g., a speaker) and a network interface device 520.

The disk drive unit 516 includes a machine-readable medium 522 on which is stored one or more sets of instructions 524 (e.g., software) embodying any one or more of the methodologies or functions described herein. The instructions 524 may also reside, completely or at least partially, within the main memory 504 and/or within the processor 502 during execution thereof by the computer system 500, the main memory 504 and the processor 502 also constituting machine-readable media.

The instructions 524 may further be transmitted or received over a network 526 via the network interface device 520.

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

It will be appreciated that, for clarity purposes, the above description describes some embodiments with reference to different functional units or processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain example embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), non-transitory, or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

Although the present invention has been described in connection with some embodiments, it is not intended to be limited to the specific form set forth herein. One skilled in the art would recognize that various features of the described embodiments may be combined in accordance with the invention. Moreover, it will be appreciated that various modifications and alterations may be made by those skilled in the art without departing from the spirit and scope of the invention.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus, comprising:
least one memory including wearable item purchase information for a plurality of users;
at least one processor in communication with the memory; and
one or more modules comprising instructions stored in the memory and executed by the processor to perform operations comprising:
determining same wearable items purchased by both of at least a first user and a second user;
identifying at least one of a first other wearable item purchased by the first user or a second other wearable item purchased by the second user, the first and second other wearable items classified in a same item category as the wearable items that are the same between the first and second users;
automatically determining a first physical fit of wearable items in the same item category for the first user and a second physical fit of the wearable items in the same item category for the second user based on the determination of the same wearable items; and
providing identification of the first other wearable item to the second user as an item recommendation, the identification including a particular size from among a plurality of sizes of the identified first other wearable item.

2. The apparatus of claim 1, wherein a number of the wearable items that are the same is equal to or greater than a threshold value.

3. The apparatus of claim 1, wherein at least one of the same wearable items, the first other wearable item, and the second other wearable item comprises articles of clothing, footwear, headwear, accessories, or a product meant to be worn by a user and offered in a plurality of sizes.

4. The apparatus of claim 1, wherein the modules executed by the processor to perform operations further comprise filtering at least one of the same wearable items, the first other wearable item, or the second other wearable item to exclude an wearable item intended for a different user or indicative of improper physical fit.

5. The apparatus of claim 1, wherein the modules executed by the processor to perform operations further comprise providing identification of the second other wearable item to the first user as an item recommendation, the identification including a particular size from among a plurality of sizes of the identified second other wearable item.

6. The apparatus of claim 1, wherein the identification of the first other wearable item includes a particular brand, a particular model, or a particular style.

7. The apparatus of claim 1, wherein the same wearable items are purchased by each of the first and second users within a pre-determined time period.

8. A method to facilitate providing item recommendations, the method comprising:
determining same wearable items purchased by both of at least a first user and a second user;
identifying at least one of a first other wearable item purchased by the first user or a second other wearable item purchased by the second user, the first and second other wearable items classified in a same item category as the wearable items that are the same between the first and second users;
automatically determining, by at least one processor, a first physical fit of wearable items in the same item category for the first user and a second physical fit of the wearable items in the same item category for the second user based on the determination of the same wearable items; and
providing identification of the first other wearable item to the second user as an item recommendation, the identification including a particular size from among a plurality of sizes of the identified first other wearable item.

9. The method of claim 8, wherein a number of the wearable items that are the same is equal to or greater than a threshold value.

10. The method of claim 8, wherein at least one of the same wearable items, the first other wearable item, and the second other wearable item comprises articles of clothing, footwear, headwear, accessories, or a product meant to be worn by a user and offered in a plurality of sizes.

11. The method of claim 8, further comprising filtering at least one of the same wearable items, the first other wearable item, or the second other wearable item to exclude an wearable item intended for a different user or indicative of improper physical fit.

12. The method of claim 8, further comprising providing identification of the second other wearable item to the first user as the item recommendation, the identification including a particular size from among a plurality of sizes of the identified second other wearable item.

13. The method of claim 8, wherein the identification of the first other wearable item includes a particular brand, a particular model, or a particular style.

14. The method of claim 8, wherein the same wearable items are purchased by each of the first and second users within a pre-determined time period.

15. A non-transitory computer readable medium including instructions, executed by a processor, causes the processor to perform operations comprising:
determining same wearable items purchased by both of at least a first user and a second user;
identifying at least one of a first other wearable item purchased by the first user or a second other wearable item purchased by the second user, the first and second other wearable items classified in a same item category as the wearable items that are the same between the first and second users;
automatically determining a first physical fit of wearable items in the same item category for the first user and a second physical fit of the wearable items in the same item category for the second user based on the determination of the same wearable items; and
providing identification of the first other wearable item to the second user as an item recommendation, the identification including a particular size from among a plurality of sizes of the identified first other wearable item.

16. The non-transitory computer readable medium of claim 15, wherein a number of the wearable items that are the same is equal to or greater than a threshold value.

17. The non-transitory computer readable medium of claim 15, wherein at least one of the same wearable items, the first other wearable item, and the second other wearable item comprises articles of clothing, footwear, headwear, accessories, or a product meant to be worn by a user and offered in a plurality of sizes.

18. The non-transitory computer readable medium of claim 15, further comprising filtering at least one of the same wearable items, the first other wearable item, or the second other wearable item to exclude an wearable item intended for a different user or indicative of improper physical fit.

19. The non-transitory computer readable medium of claim 15, further comprising providing identification of the second other wearable item to the first user as the item recommendation, the identification including a particular size from among a plurality of sizes of the identified second other wearable item.

20. The non-transitory computer readable medium of claim 15, wherein the identification of the first other wearable item comprises a particular brand, model, style, size (BMSS) combination.
